(19) United States
(12) Patent Application Publication
(10) Pub. No.: US 2010/0135666 A1
(43) Pub. Date: Jun. 3, 2010

(54) CLOCK PHASE ALIGNING APPARATUS FOR BURST-MODE DATA

(75) Inventors: Jong-deog KIM, Jeollanam-do (KR); Bong-kyu KIM, Daejeon-si (KR); Quan LE, Gwangju-si (KR); Kwang-ok KIM, Jeonju-si (KR); Dong-soo LEE, Gwangju-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/611,466

(22) Filed: Nov. 3, 2009

(30) Foreign Application Priority Data
Nov. 28, 2008 (KR) 10-2008-0119801
Mar. 27, 2009 (KR) 10-2009-0026618

(51) Int. Cl. H04J 14/08; H04J 14/00; H04L 7/00

(52) U.S. Cl. 398/99; 398/43; 375/371

(57) ABSTRACT

Disclosed is a clock phase aligning apparatus capable of synchronizing a clock signal in the middle of an upstream burst mode data bit in an optical line terminal of a passive optical network. The clock phase aligning apparatus effectively aligns a phase of a clock signal with a phase of data during an overhead period of burst mode packet data through an over-sampling scheme and a digital scheme. Burst mode data signals are subject to an over-sampling through a high speed continuous mode analog circuit and then converted into low speed parallel signals through a parallel conversion unit. Such low speed parallel signals are processed with respect to sampling patterns through a digital look-up scheme in a logic circuit device such that the phase of data is arranged with the phase of a clock signal during a limited bit stream specified in a burst mode preamble timing.

### CROSS-REFERENCE TO RELATED APPLICATION

This application claims the benefit under 35 U.S.C. §119(a) of Korean Patent Applications No. 10-2008-0119801, filed on Nov. 28, 2008 and No. 10-2009-0026618, filed on Mar. 27, 2009, the disclosures of which are incorporated by reference in its entirety for all purposes.

### BACKGROUND

1. Field

The following description relates to a passive optical network (PON), and more particularly, to a technology capable of synchronizing a clock signal in the middle of an upstream burst mode data bit in an optical line terminal forming a passive optical network.

2. Description of the Related Art

In general, in a PON using a point-to-multipoint scheme (P2MP), a single optical line terminal receives burst packet data from a plurality of optical network units (ONU)/optical network terminals (ONT) through time division multiple access (TDMA). For this reason, a receiver receiving such burst packet data needs to have a high sensitivity while having a wide dynamic range and a rapid response for different signal levels of packets.

In addition, when receiving the burst packet data from an ONU/ONT, phase alignment between data signals and clock signals needs to be rapidly and precisely achieved during an overhead timing period. However, a conventional analog circuit scheme performs a phase alignment by extracting clock signals using a phase-lock loop (PLL) scheme, and such an analog circuit scheme has a limitation in achieving rapid phase alignment required in a TDMA-PON.

Meanwhile, a conventional clock phase aligner (CPA) operating in response to burst mode data can optimally align a clock signal in the middle of a data bit by comparing a phase of input data signals with a phase of clock signals multiplexed in a phase delay scheme implemented through analog circuits. However, when developing an integrated chip (IC) for a clock data recovery (CDR)/a clock phase aligner (CPA) for an analog circuit scheme capable of supporting high speed burst mode at gigabit data transfer rate, the complications with regards to design and manufacturing processes and the uncertainty in a market entry limit development of the IC and further increase the time and cost required for developing CDRs/CPAs. Accordingly, the commercialization of an analog circuit scheme CPA for 10 G bit GPON/EPON, which has been highlighted as a next generation access network requires great time. In this regard, an intermediary technology for development of an initial system suitable for market entry is required.

### SUMMARY

Accordingly, in one aspect, there is provided a clock phase aligning apparatus capable of performing a high speed burst mode operation by using a continuous mode analog device and a digital logic device that are commonly used and have a low cost. In one aspect, there is provided a clock phase aligning apparatus, capable of effectively aligning a phase of a clock signal with a phase of data during an overhead period of burst mode packet data through an over-sampling scheme and a digital scheme. According to the clock phase aligning apparatus, first, burst mode data signals are subject to an over-sampling through a high speed continuous mode analog circuit and then converted into low speed parallel signals through a parallel conversion unit. Such low speed parallel signals are processed with respect to sampling patterns based on a digital look-up scheme in a logic circuit device such that the phase of data is arranged with the phase of a clock signal during a limited bit stream specified in a burst mode preamble timing.

In one general aspect, there is provided a clock phase aligning apparatus. The clock phase aligning apparatus includes an over-sampling unit to change one bit into a plurality of bits represented as a continuous serial signal by oversampling data amplified and converted into an electric signal after received in a form of a burst mode optical signal; a parallel conversion unit to convert the continuous serial signal into a parallel signal; a parallel phase alignment unit to group a plurality of pieces of parallel data constituting the parallel signal within a clock period in a unit of bits to which one bit is divided by the oversampling; a phase determination unit to determine a phase value by comparing parallel data of at least one of the groups with a sampling pattern preset for selecting a phase; a signal selection unit to select and output a signal corresponding to the determined phase value from the plurality of pieces of parallel data; and a controller to control a start time of the phase determination unit and to maintain the determined phase value until another phase comparison and phase determination for a next input data packet are performed.

The clock phase aligning apparatus further includes a preamble checking unit to check a bit stream pattern of the signal output from the signal selection unit. If the bit stream pattern does not match with a clock lock pattern of the preamble field received during an overhead timing, the controller controls an operation of the phase determination unit until the bit stream pattern matches the clock lock pattern.

According to the present invention, there is provided a clock phase aligning apparatus capable of performing a high speed burst mode operation by using a continuous mode analog device and a digital logic circuit device that are commonly used and have a low cost. Accordingly, the clock phase aligning apparatus can perform a phase alignment through a digital scheme using a continuous mode analog device without having to use an analog device having a burst mode function, and this thus enables a high speed next generation TDMA-PON related technology to be developed, tested and verified.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a view illustrating a burst mode data packet and a burst mode overhead timing for an optical line terminal defined in the GPON standard (G. 984.2);

FIG. 2 is a block diagram illustrating an exemplary clock phase aligning apparatus for burst mode data;

FIG. 3 is a view showing exemplary clock phase synchronization;

FIG. 4 is a view showing an exemplary phase determination method;

FIG. 5 is a view showing a clock phase alignment process; and

FIG. 6 is a view illustrating an exemplary clock phase aligning apparatus using a field programmable gate array (FPGA).

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

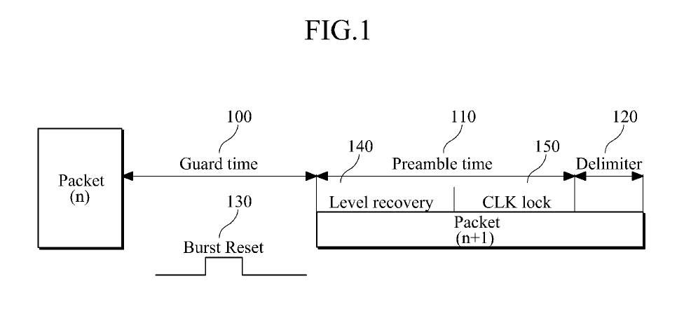

FIG. 1 is a view illustrating a burst mode data packet and burst mode overhead timing for an optical line terminal defined in the GPON standard (G. 984.2). The overhead time is provided between burst mode packets and includes a guide time 100, a preamble time 110 and a delimiter time 120. A burst reset 130 is a signal provided from a media access control (MAC) specified above a physical layer, and is used for synchronizing an initiation timing of a burst mode transimpedance amplifier (TIA), a burst mode limiting amplifier (LA), a clock phase aligner (CPA) and/or a clock data recovery (CDR). The preamble time 110 is divided into a level recovery field 140 for stabilizing the output of the TIA/LA in the beginning of a burst mode data and a clock lock field 150 used for a clock synchronization with respect to a stabilized preamble data signal.

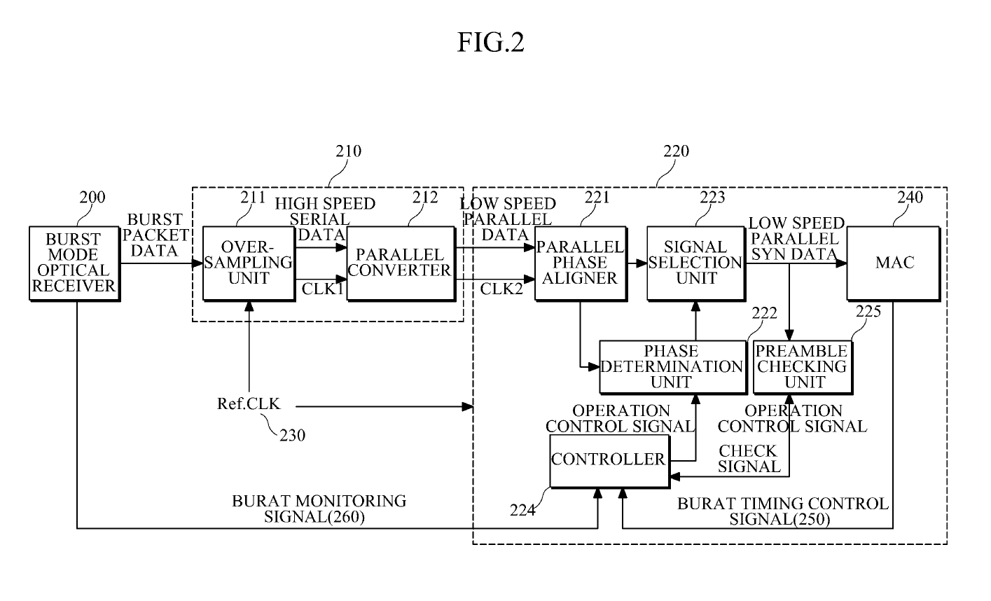

FIG. 2 is a block diagram illustrating an exemplary clock phase aligning apparatus for burst mode data.

A burst mode optical receiver 200 includes a photodiode (PD), a burst mode transimpedance amplifier (TIA) and a burst mode limiting amplifier (LA). The burst mode optical receiver 200 receives high-speed burst mode data packets having different optical input intensities from an ONU/ONT and then performs amplification and conversion on the high-speed burst mode data packet while maintaining a high sensitivity. As a result, electric signals having predetermined output intensities are output.

An over-sampling unit 211 performs an over-sampling on burst mode data input from the burst mode optical receiver 200 in a manner to convert 1 bit of data having an L bit-rate into M-bits of data having an interval of 1/M such that high-bit signals having M phase information and M×L bit-rate are obtained. For example, such an oversampling operation can be performed by operating a continuous mode clock data recovery, which performs a high speed operation relative to an input data speed such that an input data signal is synchronized with a high speed internal clock locked with an Ref. CLK 230 serving as an external synchronization clock. A parallel conversion unit 212 converts the high speed continuous signals into low-speed parallel signals at a ratio of 1 to N (N>M).

A parallel phase alignment unit 221 arranges bit streams of low-speed parallel signals having a ratio of 1 to N within a clock period into M groups (for example, M=4). When arranging the bit streams, if an additional parallel conversion is necessary, the signals, which have been converted at a ratio of 1 to N, are converted through a 1:P parallel conversion unit serving as a supplementary parallel conversion unit to obtain parallel signals having a further lower speed of N×P. Such an additional parallel conversion may be required to achieve processing speeds corresponding to channels used in respective logic circuit devices.

A phase determination unit 222 determines an optimum phase based on patterns of N pieces of parallel data within a clock period. The clock phase arranging apparatus is provided with a pattern look-up table having phase selection information corresponding to each data pattern. The phase determination unit 222 performs a data pattern comparison on at least one of the M groups including N pieces of parallel data within a clock period in reference to the pattern look-up table, thereby determining respective phases corresponding to data patterns. After that, the phase determination unit 222 compares phase values specified at respective groups with each other and determines a phase, which has a relatively high phase value and corresponds to a bit value, as a final phase. After that, a signal selection unit 223 selectively outputs a bit stream corresponding to the determined phase value.

A controller 224 controls an operation timing of the phase determination unit 222 based on a burst timing control signal 250 transmitted from a medium access control (MAC) 240 or a burst monitoring signal 260 transmitted from the burst mode optical receiver 200 such that the operation timing matches a start of a CLK lock field. For example, the controller 224 allows the phase determination unit 222 to operate just after receiving the burst timing control signal or the burst monitoring signal or to operate after a predetermined time has lapsed after receiving the burst timing control signal

A preamble checking unit 225 further included in the clock phase aligning apparatus checks patterns of parallel signals that are output from the signal selection unit 223 within a clock period. The controller 224 determines whether the signal pattern checked by the preamble checking unit 225 corresponds to a clock lock pattern. The clock lock pattern may be provided in the form of 101010 . . . or 010101 . . . . If the preamble checking unit 225 determines that the signal pattern checked by the preamble checking unit 224 does not correspond to the clock lock pattern, the controller 224 allows the phase determination unit 222 to perform an additional operation. On the other hand, if the preamble checking unit 225 determines that the signal pattern does correspond to the clock lock pattern, the controller 224 allows the phase determination unit 222 to stop phase comparison and phase determination operations, and allows the signal selection unit 223 to keep outputting a signal having the determined phase value while a corresponding burst mode data packet is transmitted.

In this regard, the above function of the controller 224 can effectively compensate a phase alignment error caused when an inaccurate signal is generated during an operation time of the phase determination unit 222, that is, when a time of initiating phase comparison and phase determination based on the burst reset signal does not precisely match the clock lock field used for clock synchronization. In addition, since the controller 224 allows the phase determination unit 222 to repeatedly operate based on the signal checked by the preamble checking unit 225 until the preamble clock lock pattern for a clock lock is generated, a start timing of a clock synchronization process through the phase comparison and determination does not need to be precisely controlled in response to the burst reset timing.

Meanwhile, as described above, the oversampling unit 211 and the parallel conversion unit 212 are implemented by an analog device 210 including a 1:16 deserializer and a continuous mode CDR capable of locking an internal clock with the Ref. CLK 230. In addition, the parallel phase alignment unit 221 and the phase determination unit 222 are implemented by a logic circuit device 220 including a field programmable gate array (FPGA) or an application specific integrated circuit (ASIC).

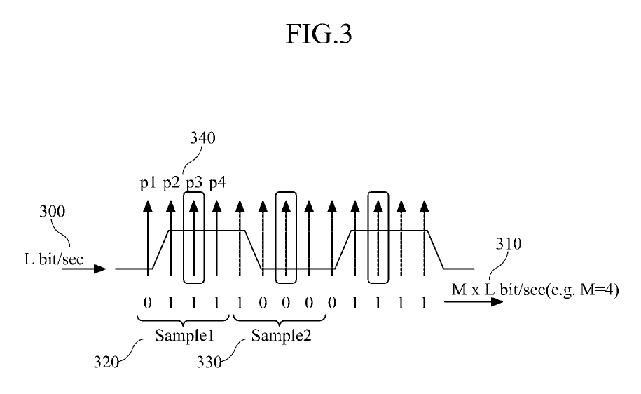

FIG. 3 is a view showing exemplary clock phase synchronization.

An input data 300 of L bit-rate (for example, 2.5 Gbps) input from the burst mode optical receiver 200 is oversampled in the oversampling unit 211, thereby generating high-bit signals having a M×L bit-rate (for example, 10 Gbps) and synchronized with Ref. CLK, in which 1 bit of the input data 300 is converted into output data 310 having M phases p1, p2, p3 and p4 (for example, M=4). For example, as shown in FIG. 3, if the data is sampled as a sample-1 320 having a 0111 bit stream and a sample-2 330 having a 1000 bit stream, a phase (p3) is selected, thereby synchronizing a clock phase in the middle of the input data 300.

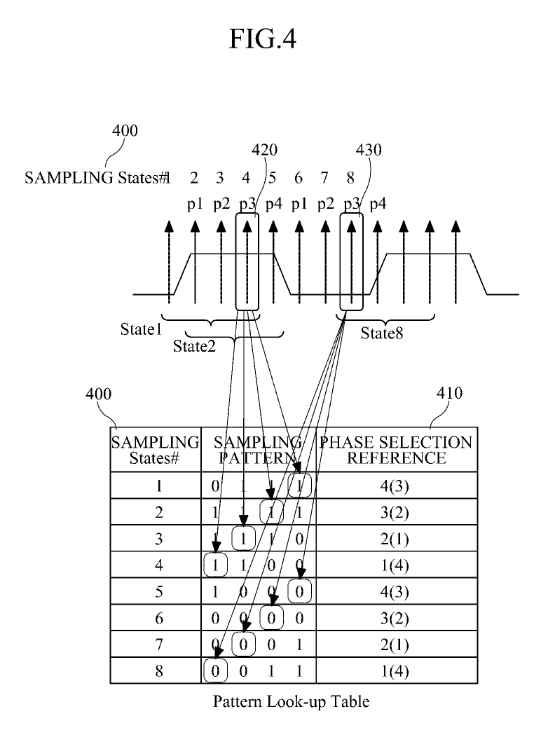

FIG. 4 is a view showing an exemplary phase determination method.

FIG. 4 shows a pattern look-up table including the number of sampling states 400 obtainable through a phase sampling (M=4) and a phase selection reference 410 used for comparing and determining phases based on the sampling patterns. If an input data signal of 1 bit is oversampled and thus converted into a high speed signal of 4 bits, the possible number of sampling states 400 is 8 as shown in the pattern look-up table. In the case of a sampling pattern of state 1, the third-phase bit or the fourth-phase bit is selected, thereby increasing the possibility of aligning the clock phase in the middle of input data. In the case of a sampling pattern of state 2, the second-phase bit or the third-phase bit is selected, thereby increasing the possibility of aligning the clock phase in the middle of input data. In the case of a sampling pattern of state 3, the first-phase bit or the second-phase bit is selected, thereby increasing the possibility of aligning the clock phase in the middle of input data. If values of 4, 3, 2 and 1 of the phase selection reference 410 are respectively selected in state 1, state 2, state 3 and state 4, a clock phase is aligned corresponding to the third phase (p3) of logic high (1). Similarly, if values of 4, 3, 2 and 1 of the phase selection refection 410 are respectively selected in state 5, state 6, state 7 and state 8, a clock phase is aligned corresponding to the third phase (p3) of logic low (0).

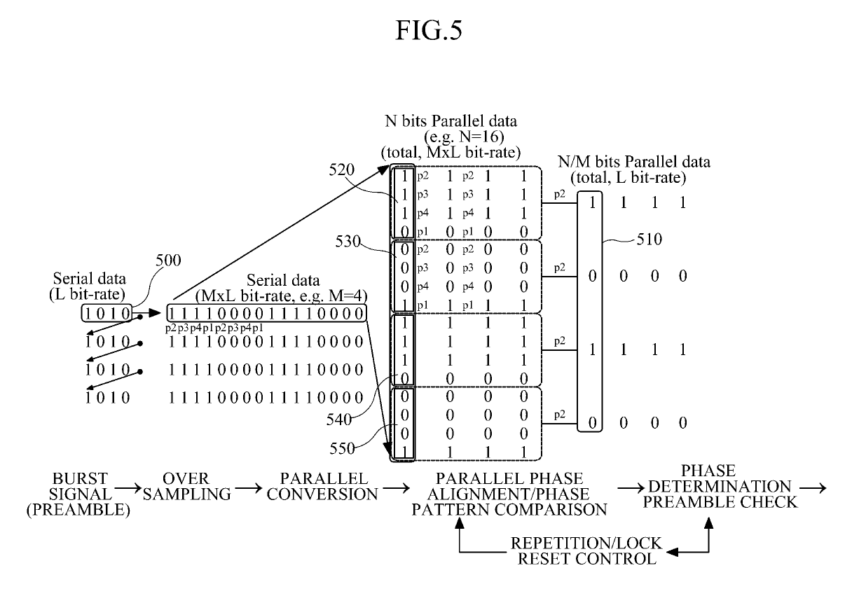

FIG. 5 is a view showing a clock phase alignment process.

FIG. 5 shows a CLK lock signal pattern of a preamble field input from the burst mode optical receiver 200 during an overhead timing. A 101010 bit stream corresponding to the CLK lock signal pattern is sequentially subject to an over-sampling, a parallel conversion, a parallel phase alignment, a phase determination and a signal selection and thus finally is output in the form of low speed parallel signals. As shown in FIG. 5, an input data 500 having a 1010 bit stream (L=4) is subject to the over-sampling (M=4), the parallel conversion (N=16), the phase comparison and the phase determination and thus is converted into low speed parallel data having a bit rate of 4 (N/M=4) synchronized with the clock. Meanwhile, if the input data 500 is subject an additional parallel conversion (N×P), low speed parallel data having a (N×P)/M bit rate is output.

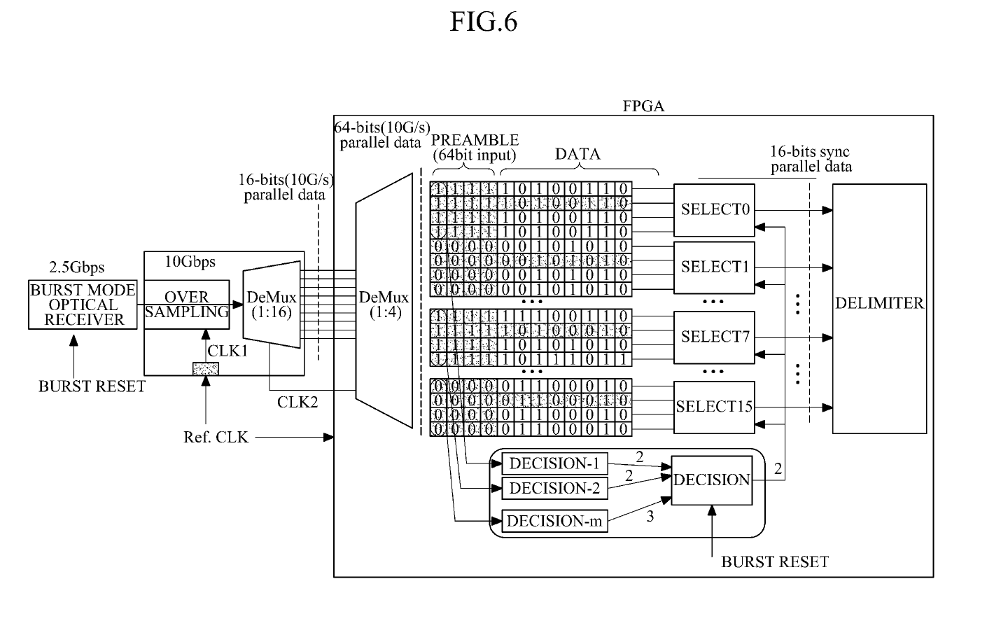

Reference numerals of 520, 530, 540 and 550 represent groups of 4-bits that are used for the phase comparison. One or more groups within a clock period may be subject to the phase comparison and phase determination to minimize an alignment error of phases. In FIG. 5, a plurality of groups are subject to the phase comparison and phase determination. In detail, the phase values are compared with each other and a phase having a relatively high phase value and corresponding to a bit value is determined as a final phase. In FIG. 5, all phase values obtained through the phase comparison correspond to a phase of p2, so that the phase p2 is determined as a final phase. By performing the phase comparison and phase determination on a plurality of groups, the error in determination of phases can be reduced. FIG. 6 is a view illustrating an exemplary clock phase aligning apparatus using a field programmable gate array (FPGA), in which an additional parallel conversion unit 600 is provided.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A clock phase aligning apparatus comprising:
an over-sampling unit to change one bit into a plurality of bits represented as a continuous serial signal by oversampling data amplified and converted into an electric signal after received in a form of a burst mode optical signal;
a parallel conversion unit to convert the continuous serial signal into a parallel signal;
a parallel phase alignment unit to group a plurality of pieces of parallel data constituting the parallel signal within a clock period in a unit of bits to which one bit is divided by the oversampling;
a phase determination unit to determine a phase value by comparing parallel data of at least one of the groups with a sampling pattern preset for selecting a phase;
a signal selection unit to select and output a signal corresponding to the determined phase value from the plurality of pieces of parallel data; and
is a controller to control a start time of the phase determination unit and to maintain the determined phase value until another phase comparison and phase determination for a next input data packet are performed.

2. The apparatus of claim 1, wherein the over-sampling unit is provided as a continuous mode clock data recovery circuit having an over-sampling function.

3. The apparatus of claim 1, wherein, the phase determination unit obtains a plurality of phase values by comparing each of the groups with the sampling pattern, and selects a relatively high phase value from the phase values as a final phase value.

4. The apparatus of claim 1, wherein the controller controls the start time of the phase determination unit based on a timing control signal transmitted from a medium access control (MAC) layer or a burst monitoring signal received from a burst mode optical receiver.

5. The apparatus of claim 4, wherein the controller controls the start time of the phase determination unit such that the phase determination unit starts to operate corresponding to a clock lock field of a preamble field of an input data signal based on the timing control signal or the burst monitoring signal.

6. The apparatus of claim 1, further comprising a preamble checking unit to check a bit stream pattern of the signal output from the signal selection unit,
wherein if the bit stream pattern does not match with a clock lock pattern of the preamble field received during an overhead timing, the controller controls an operation of the phase determination unit until the bit stream pattern matches the clock lock pattern.

7. The apparatus of claim 1, further comprising a supplementary parallel conversion unit to additionally perform parallel conversion on a bit stream converted by the parallel conversion unit and then to output the bit stream to the parallel phase alignment unit.

8. The apparatus of claim 1, wherein the clock phase aligning apparatus is provided in an optical line terminal forming a time division multiple access (TDMA)-passive optical network.

9. The apparatus of claim 1, wherein the over-sampling unit and the parallel conversion unit are provided as an analog device.

10. The apparatus of claim 9, wherein the phase determination unit, the signal selection unit and the controller are implemented by a logical circuit including a field programmable gate array (FPGA) or an application specific integrated circuit (ASIC).
